(19) United States
(12) Patent Application Publication
(10) Pub. No.: US 2003/0071860 A1
(43) Pub. Date: Apr. 17, 2003

(54) System and method for managing graphical components

(76) Inventors: Edward Wayne Goddard, Calgary (CA); Zachariah Scott, Calgary (CA)

Correspondence Address: FAY KAPLUN & MARCIN, LLP, 15O BROADWAY, SUITE 702, NEW YORK, NY, 10038, US

(21) Appl. No.: 09/942,376

(22) Filed: Aug. 29, 2001

(51) Int. Cl. G09G 5/00

(52) U.S. Cl. 345/866

(57) ABSTRACT

A software package, comprising a graphical component including a plurality of images, each image corresponding to a state of the graphical component, wherein the graphical component is identified by a name, and a skin manager configured to search for the graphical component in a predetermined location using the name and retrieve the graphical component.

### BACKGROUND INFORMATION

A user interface is the portion of a software program that connects the information handling system to the human operator. It allows the system and user to communicate the input and output of a program. A graphical user interface (GUI) is a common type of user interface. A GUI is a visual display presented to a user via a display, e.g., CRT, LCD, etc. GUIs take advantage of the graphic capabilities of the displaying device to make the program easier to use by displaying graphical screen images as well as typed text. In certain instances, the graphical images on the screen replace some of the functions traditionally reserved for keyboard input. These functions may be accessed by the user in a variety of manners (e.g., mouse click, touch screen, input, etc). The graphical images displayed may be, for example, menus, icons, etc.

Software code may be associated with the graphical images in order to allow the images to possess desired functions. A combination of a graphical image and the associated software code is commonly referred to as a “widget.” Examples of widgets include icons, pointers, scroll bars, dialog boxes, etc. Programs that incorporate GUIs typically display many widgets, which may be utilized by the user to communicate with the program and/or control the events of the system.

### SUMMARY OF THE INVENTION

A software package, comprising a graphical component including a plurality of images, each image corresponding to a state of the graphical component, wherein the graphical component is identified by a name, and a skin manager configured to search for the graphical component in a predetermined location using the name and retrieve the graphical component. In addition, a system, comprising a skin creation module, including a skin user interface, configured to create a skin including a plurality of images, a skin manager creation module, including a skin manager user interface, configured to create a skin manager including methods to search a predetermined location and a skin development module configured to associate the skin manager with the skin.

A method, comprising the steps of identifying a graphical component by a name, storing the graphical component in a predetermined location, searching the predetermined location, using the name, for the graphical component, and retrieving the graphical component. Furthermore, a method, comprising the steps of creating a skin including a plurality of images, each image corresponding to a state of the skin, storing the skin in a predetermined location and linking a skin manager to the skin, wherein the skin manager includes methods to search the predetermined location.

### BRIEF DESCRIPTION OF DRAWINGS

FIG. 1 shows an exemplary GUI displayed as a web browser;

FIG. 2 shows exemplary states of a skinnable component according to the present invention;

FIG. 3 shows an exemplary skin pack for a web browser according to the present invention;

FIG. 4 shows an exemplary process to create and load a skin for a skinnable component according to the present invention;

FIG. 5 shows an exemplary GUI for creating a skin and organizing the skin images into a predetermined structure according to the present invention;

FIG. 6 shows an exemplary GUI for creating a skin manager according to the present invention;

FIG. 7 shows an exemplary process for searching and loading an image for a skinnable component according to the present invention.

### DETAILED DESCRIPTION

The present invention may be further understood with reference to the following description of preferred exemplary embodiments and the related appended drawings, wherein like elements are provided with the same reference numerals. The present invention relates to systems and methods for developing and accessing graphical user interfaces (“GUIs”) for software. Some portions of this description will refer to exemplary embodiments of the present invention using the Java® programming language. It should be understood that the present invention may be implemented using any programming language.

The present invention may be implemented on any development program that supports the building of GUIs for an application or any application which includes GUIs as part of its user interface. For example, an integrated development environment (“IDE”) may include a GUI editor that supports the Java beans 1.01 specification. An example of an application which includes GUIs as part of its users' interface may be a web browser such as IceStorm® sold by Wind River Systems, Inc. of Alameda, Calif. Those skilled in the art will understand that a GUI editor and web browser are only exemplary and the present invention can be applied to any type of display system having a user interface.

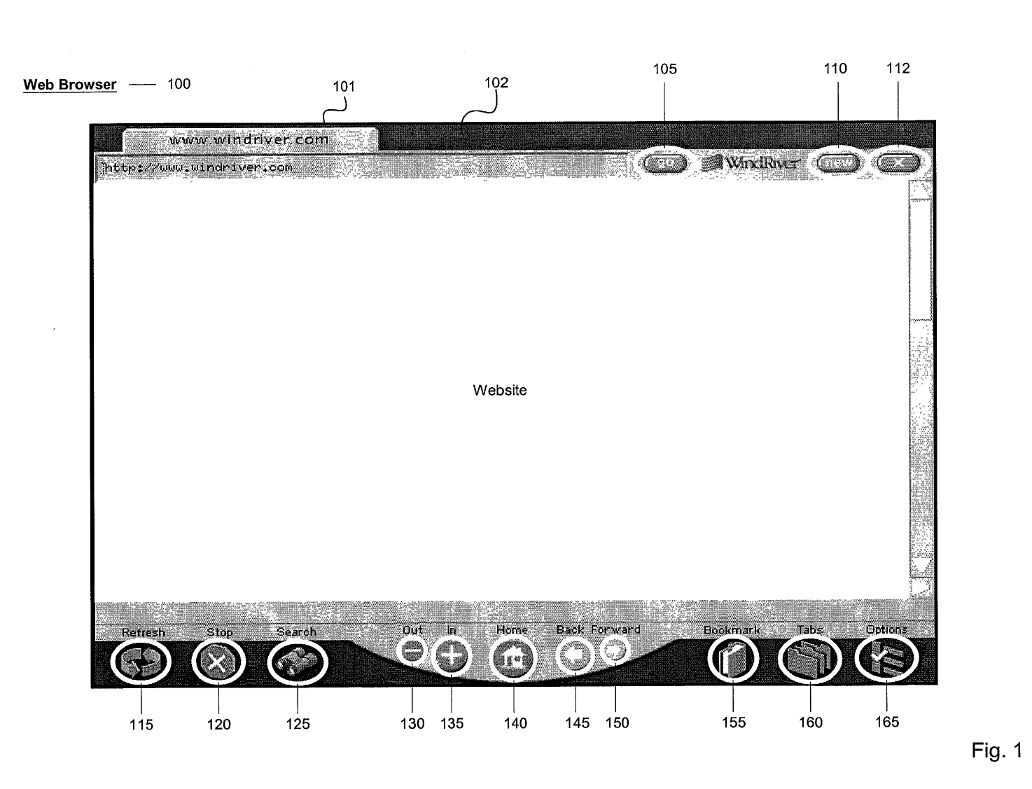

FIG. 1 shows an exemplary GUI 101 for web browser 100, which is a software application that is used to locate and display web pages. GUI 101 has a series of components (or buttons) 105-165. Each of the components 105-165 is represented by a different image, and by selecting an image, for example, by clicking the image with a mouse, the user may instruct web browser 100 to perform the desired function. For example, button 112 depicts an oval centered by an “X.” It is generally known that button 112 is associated with the function of closing the web browser 100. Thus, when a user presses button 112 on GUI 101, web browser 100 performs the function of closing the web browser 100. Similarly, button 145 shows a circle centered by a block left arrow “ [symbol] .” When the user selects button 145, web browser 100 will perform the function of returning to the last displayed web page. Those skilled in the art will recognize that the user may interact with a GUI in more manners than depicted in FIG. 1, for example, by moving objects on the desktop, choosing commands from menus, and manipulating window controls, such as scroll bars. The user will be generally familiar with the functions associated with each component in any particular application.

The term “skin” refers to a particular look of a GUI. Developers apply a skin to a system in a way that allows each instance of the skin to provide a significantly different look while maintaining similar or identical functionality. A skin may be a bundle of images. Each image represents one aspect or state of a component. A skinnable component is a component which implements a skin to manage the images for the component. For example, a single skinnable button may contain a set of four images. The four images may correspond to one of the following states: normal, highlighted, pressed, or disabled. Each image may be stored in a separate file in any number of file formats (e.g., graphical interface format or “.gif”, tagged image filed format or “.tif”, joint photographic experts group or “.jpg,” etc.). Thus, in the example of a button having four states, there may be four separate and independent image files associated with the skinnable button. The particular image displayed by the GUI for the skinnable button may depend on the state of the application and/or on actions taken by the user. Although the look of the button displayed by the GUI may change based on which of the four images is displayed, the function associated with the button may remain identical.

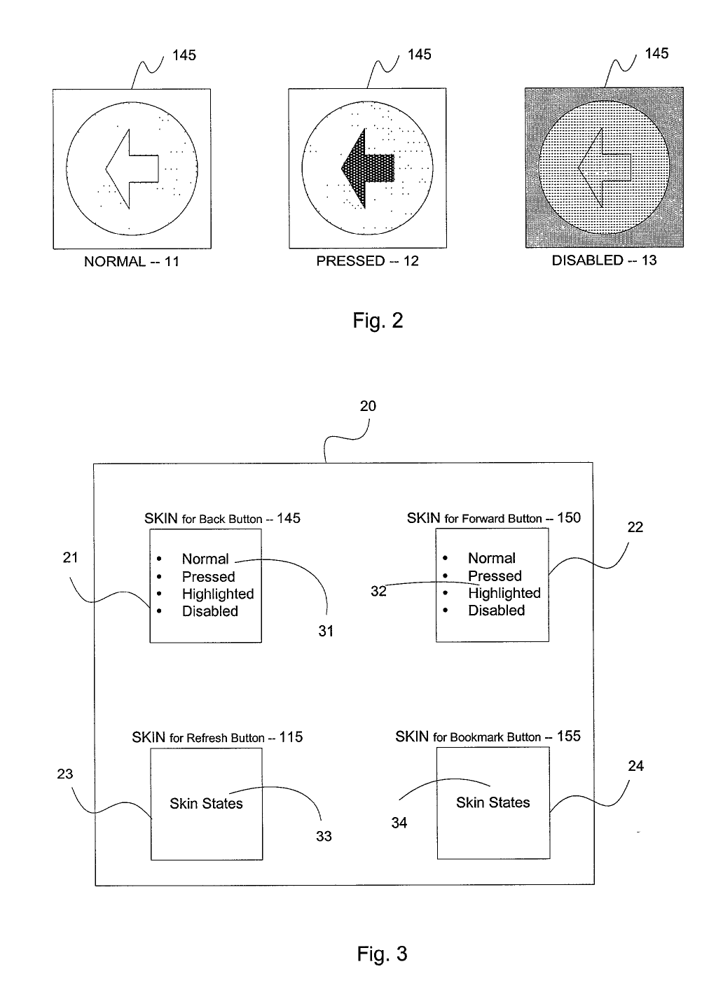

FIG. 2 illustrates an exemplary set of images 11-13 representing the different states of skinnable back button component 145. As described above, each skinnable component may have different images corresponding to the state that it is representing. Three states 11-13 are exemplified in this figure: normal state 11, pressed state 12 and disabled state 13. Each of states 11-13 is represented by a different image and appears based on the state of the application and/or actions taken by the user. For example, the skin depicted for back button 145 in disabled state 13 indicates that the functionality normally associated with back button 145 is disabled, meaning the user does not have the option of pressing back button 145. This skin may be displayed when a user first enters web browser 100, when there is no previous web page to view. This is an example of a skin being displayed based on the state of the application.

The skin for back button 145 in normal state 11 is the skin displayed when the user may select the functionality associated with back button 145. A user interacting with GUI 101 will recognize that the function associated with back button 145 is available when the skin of normal state 11 is displayed. If the user selects the function associated with back button 145 by, for example, placing the mouse cursor over back button 145 and clicking the mouse, the skin for back button 145 in pressed state 12 may be displayed. Back button 145 in pressed state 12 provides positive feedback to the user that the desired action (e.g., selecting back button 145) has occurred. Pressed state 12 is an example of a skin being displayed based on an action by the user.

Those of skill in the art will understand that a single component may include any number of images. The example of FIG. 2 shows three images, but there may be more or less depending on the function of a particular component. For example, referring to FIG. 1, border 102 may be a skin having a single image that is used in GUI 101. In this case, border 102 does not change in response to an action by the user or application, but it is an integral part of GUI 101 and must be displayed in order for GUI 101 to have the look desired by the developer. This also illustrates that skinnable components are not limited to buttons, but may be any component used on a GUI.

Several skins may be grouped together for an entire GUI. FIG. 3 shows a skin pack, which is an example of such a grouping, for GUI 101 in FIG. 1. Those skilled in the art will understand that FIG. 3 does not depict the skins for every component of GUI 101, only selected skins for exemplary purposes. Skin pack 20 is a set of skins 21-24, designed to work together to present the overall look of GUI 101. For example, back button 145 may be given its appearance by the skin 21, but the entire GUI 101 is given its appearance by skin pack 20 containing skins 21-24 for back button 145, forward button 150, refresh button 115, and bookmark button 155, respectively. Each skin 21-24 has a set of instances 31-34, respectively, that represents the different images for each state of the component. For example, skin 21 for back button 145 has set 31 of instances—normal, pressed, highlighted, and disabled. Similarly, skin 22 for forward button 150 has a set of instances 32 that represents the group of possible states forward button 150 can enter. There are a multitude of possible skinnable components that can be included in a skin pack with numerous different states for the skins that are not depicted in FIG. 3, for example, skins for a panel or a scroll bar.

In addition to applying different skins to individual components, the user can change the appearance of the entire interface by changing the overall look of the skin pack. For example, the user can change web browser 100 from a “metallic” look to an “aqua” look. Each of the components 102-165 will accordingly change, creating a separate GUI. The components will still have different images for each of the functions as described above. However, the corresponding functions for the components will remain the same.

Developers may create user interfaces by placing components on the screen in a visual manner (e.g., GUI 101, as described above). For example, a GUI editor may allow a developer to “drag and drop” a component on the GUI as it is being developed. Each of the components may be a standard or a custom component which adds a specific function to the application. The components may be considered as part of a framework into which each of the components contribute their functionality. The images or skins for a component may be stored anywhere on the system (e.g., hard drive, flash memory, etc.), and may be stored in databases, libraries, etc. Developers may assign a skin or multiple skins to a skinnable component (e.g., buttons, panels, labels, etc.) and then attach event handlers to these components to tie them to the underlying functionality of the application.

Knowing that each component may have a different image associated with a component based on the state of the application and/or an action taken by the user, each user interface (e.g., GUI 101) may have multiple components and each application may have multiple GUIs. A developer may be faced with a considerable number of images to manage. Additionally, there may be multiple developers working on the development of a single application. This may lead to redundant code and a disorganized collection of images on the file system. The present invention simplifies the development of GUIs for applications in an exemplary embodiment by defining a skin manager for the components. The skin manager allows the image file organizational details to remain transparent to both the GUI and the application, and simplifies development by reducing the code to obtain images to one call. The skin manager may be implemented via the application program associated with the GUI, as a stand-alone program, or as part of any other software resident on the device (e.g., the operating system). Additionally, there may be multiple skin managers for a single application (e.g., a skin manager for each skin pack in an application).

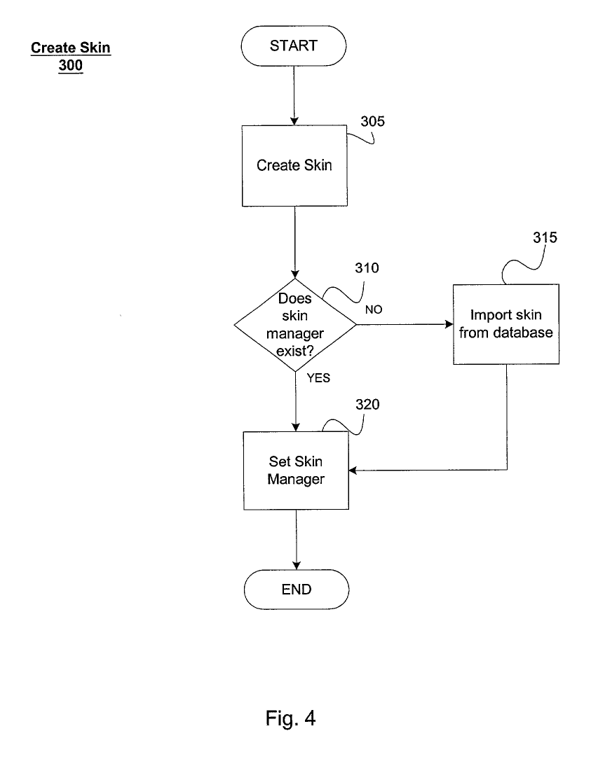

FIG. 4 shows an exemplary process 300 to create and load a skin for a skinnable component. In step 305, the developer creates the skin for the skinnable component. To create the skin, the developer may organize the images to be used for the component into a predetermined structure. An exemplary embodiment of a predetermined structure is the placing of image files in a directory structure on the file system. Such a structured layout on the file system allows for easy customization of the application. An example of a directory structure that such a file system would follow is:

{directory}/{base package}/{skinPack}/{skinName}/{skinImage}.{image extension}

For example, the skin for back button 145 may contain the following images corresponding to the previously described states:

normal.gif

pressed.gif

highlighted.gif

disabled.gif

Thus, the file directory storage for the normal skin image may be:

C:/com/windriver/skins/icestorm/gui_101/backbutton/normal.gif

In this example, the directory is C:/ and the base package is /com/windriver/skins. The skin pack is icestorm/gui_101 which may refer, for example, to the IceStorm® web browser application described above and GUI 101 of FIG. 1. The skin name is backbutton describing the component and the state name is normal. Each of the remaining images for the component may be stored in a similar fashion. Those of skill in the art will understand that each of the elements of the exemplary file structure (e.g., directory, base package, skinPack, skinName, etc.) may be set interactively by the developer and/or automatically by the application when organizing the skinnable component.

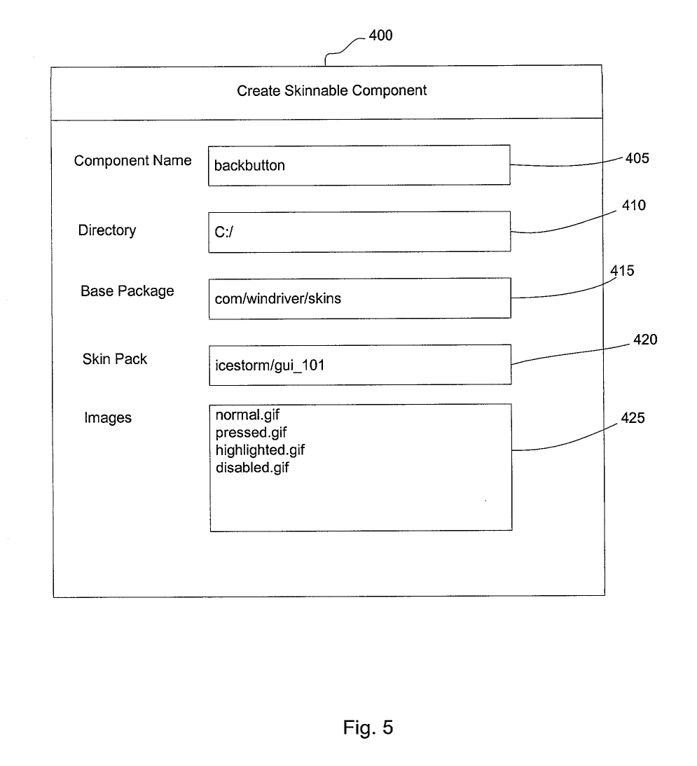

FIG. 5 shows a first exemplary GUI 400 for creating a skin and organizing the skin images into a predetermined structure. GUI 400 may be used by the developer to organize the images for a particular skin. In this example, it is the skin for back button 145 described above. First, the developer selects the name for the skin in field 405 (e.g., backbutton). The name of the skin is the search parameter that may be used by the corresponding skin manager to find the images when requested by the application. The process for searching for a skin will be described in greater detail below. The developer may then select the directory where the skin should reside in field 410 (e.g., C:/). GUI 400 may have a default directory set that the developer may select or include a directory of the developer's choice. Additionally, there may be instances where no directory is included. For example, in a Java® application, the default may be the class path and the skin will be stored in the class path. Similarly, the developer may then select the base package in field 415 (e.g., com/windriver/skins). In field 420, the developer enters the skin pack (e.g., icestorm/gui_101). Once again, GUI 400 may contain a default base package and skin pack which the developer may select or include a base package and/or a skin pack of the developer's choice. It may be common for the developer to enter the default skin pack when creating a skinnable component because there may not be any GUIs created at that time. For example, GUI 101 of FIG. 1 may not exist until after each of the skinnable components contained in GUI 101 are created. Thus, the developer does not know the skin pack to which the component will belong and, therefore, the default skin pack may be selected by the developer. Those skilled in the art will understand that there may be provisions for changing the skin pack of a skinnable component from the default skin pack (or any other skin pack) to a different skin pack after specific GUIs are developed. Finally, the developer may select the images to include for the skin in field 425. After the developer has filled in all the fields 405-425 of GUI 400, the application (e.g., the IDE) may automatically store the images, for example, in the directory structure described above using the information from GUI 400.

Those of skill in the art will understand that GUI 400 of FIG. 5 is exemplary and that there are numerous other manners of creating and organizing a skin. For example, the developer may organize the skin based on filling in information for each of the images on the system (e.g., skin name, directory, etc.). Additionally, the skin information for a skinnable component may be included in the application using other graphical (e.g., command tree) or non-graphical (e.g., command line interface (“CLI”)) manners.

In addition, any other preparation for allowing the skin to use the services of a skin manager are performed in step 305. For example, in a Java application, the component may need to implement an interface to the skin manager. The following shows exemplary JAVA® code for setting up a skin manager interface:

public interface Skinnable {

public void setSkin (String skin);

public String getSkin( );

public void setSkinManager(SkinManager skinManager)

public SkinManager getSkinManager( );

}

Those skilled in the art will understand that the present invention may be implemented via any programming language and the use of JAVA® is only exemplary. In this example, an interface is created to allow skinnable components to access the functions or methods of the skin manager. In addition to standard component methods, a component implementing such an interface may use the skin manager as a strategy to obtain images indexed by the skin parameter (e.g., the skin name). hi this example, the skin parameter is a string which is used by the skin manager to find a requested skin.

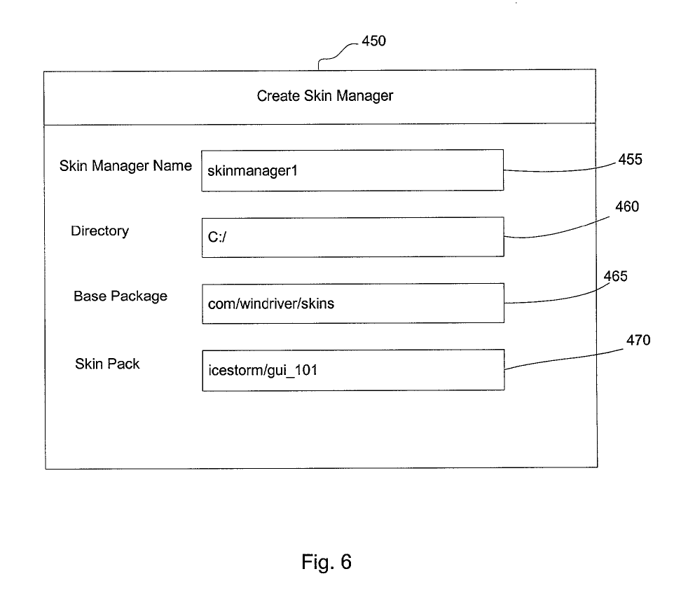

Referring back to FIG. 4, the process continues to step 310 where it is determined whether the appropriate skin manager exists for the skinnable component. There may be a default skin manager available in the application. If the appropriate skin manager does not exist in step 310, the process continues to step 315 where the developer may create a new skin manager. FIG. 6 shows an exemplary GUI 450 for creating a skin manager. GUI 450 allows a developer to configure a skin manager to be used in retrieving image files for a skinnable component. In this example, the skin manager has four properties in fields 455-470 to be filled in by the developer. The first field 455 is the name of the skin manager (e.g., skinmanager1). The next property in field 460 is the directory in which the skin manager should look for the image files of the skin (e.g., C:/). There may be instances where no directory is included in the skin manager, for example, in a Java® application, the lack of a directory may indicate that the skin manager should search the class path for the skin images. The developer may then fill in field 465 which indicates the base package (e.g., com/windriver/skins) where the skin manager will search for images. Finally, the developer may fill in field 470 which indicates the skin pack (e.g., icestorm/gui_101) where the skin manager will search for images. Any of fields 460-470 may contain default values that the developer may select or include values of the developer's choice. After all the fields are filled in by the developer, the application (e.g., the IDE) may automatically create an instance, function, procedure, etc. of a skin manager having a configuration corresponding to the entries in GUI 450.

Those of skill in the art will understand that GUI 450 is only exemplary and that there may be any number of methods, graphical and non-graphical, to create a skin manager. The important information that the developer includes in the skin manager is the location or locations for the skin manager to search for skin images. If the skin manager is not searching in the correct location, it may not find the desired image for the skinnable component. Those of skill in the art may also understand that it may be more efficient to create the skin manager or set of skin managers before creating the skinnable components. In this scenario, the developer may have a skin manager or a set of skin managers that are configured to search a location or locations within the system. The developer may then create skinnable components which populate these locations where the developer knows that a skin manager will search.

Referring back to FIG. 4, after it is determined that the appropriate skin manager exists in step 310 or after the appropriate skin manager is created in step 315, the process continues to step 320 where the skin manager is set for the skinnable component. For example, skinnable back button 145 (configured via GUI 400 of FIG. 5) may have its skin manager set for skinmanager1 (configured via GUI 450 of FIG. 6). Thus, skinmanager1 would be responsible for finding and loading the images for skinnable back button 145. One manner of setting the skin manager for a skin may be to include an additional field on GUI 400 for the developer to fill in the skin manager that should be associated with the skin. When process 300 is completed, a skinnable component is ready for use by a developer or user to create GUIs.

Referring back to FIG. 1, it may be considered that each of the components 102-165 included in GUI 101 is a skinnable component. Thus, when the skinnable component was created by the developer, the images for the component were stored in a structured manner and a corresponding skin manager was set for each skinnable component. As described above, each component may have the same skin manager or a different skin manager. The developer and/or user who is creating or editing GUI 101 may have, for example, a list of available skinnable components that may be included in the GUI. The list may include, for example, the skin name, a brief description of the skin and the available states (e.g., the images available for the component). Since each of the components are skinnable components, the user does not need to know where the images are located because a component's corresponding skin manager will search and find the image for the component if it is included on the GUI.

The user may then select the skinnable components that the user desires to include on the GUI. The framework for the GUI may include the skin name and the state or a set of rules as to when to display the component in a particular state. Implementing the skinnable components allows users and developers to assign images to the GUIs without directing the program by the file extension or specific location. The skin manager supports a strategy for the users to access the images by reduced coding in skin parameters and simplified directory structure. Those skilled in the art will understand that when a developer or user is creating a GUI using skinnable components it may be possible to make edits to the skinnable components. Because of the structured arrangement of the skinnable components according to the present invention, these edits may be easily implemented even by users that are unfamiliar with basic computer programming principles. For example, as the user is developing a GUI, the user may desire to keep all components for a particular GUI or set of GUIs in a particular skin pack. Using, for example, GUI 400, a user may change the skin pack configuration for the skinnable components in this embodiment that the user selects to include on the GUIs that are being developed. A further example is that the developer that initially created the skinnable components may have set the skin manager for each of the skinnable components to a default skin manager. As the user is making edits to skinnable components (e.g., the skin pack changes described above), the user may desire to implement a custom skin manager to be able to access the skinnable components in the newly created skin packs. The use may create a new skin manager, for example, by filling out GUI 450. Thus, when a skinnable component is created using process 300 as described with reference to FIG. 4, the skinnable component does not need to be static, a user or developer may dynamically change its properties in order to be most useful for the particular application. In the alternative, the user does not need to make any edits to the skinnable components or the skin managers. The default configurations may be used as an effective manner of searching and loading images for the skinnable components. In this manner, the entire structure of the skinnable components and the skin manager remains transparent to the user.

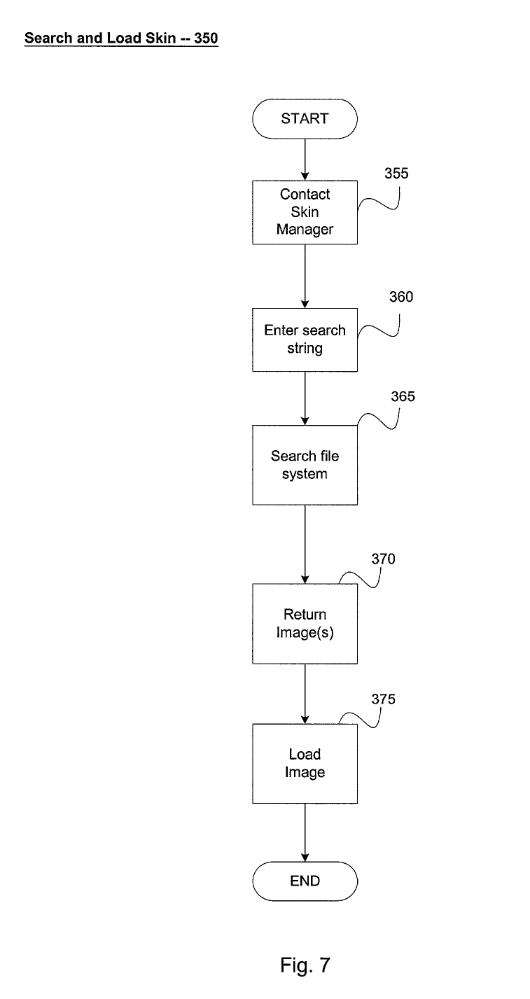

After a GUI is created and the application is running, the application must retrieve the component images in order to display the GUIs for the application. FIG. 7 shows an exemplary process 350 for searching and loading an image for a skinnable component. When the GUI is going to be displayed by the application, it determines the skinnable components that are included in the GUI. For example, GUI 101 of FIG. 1 may determine that back button 145 is a skinnable component. In step 355, the skinnable component will contact its corresponding skin manager. Continuing with the example started above, back button 145 would contact skinmanager1. In step 360, the skinnable component sends a search string to the skin manager to search for the images for the skinnable component. The search string may be, for example, the name of the skin(e.g., backbutton). As described above, when the skinnable component was created, its corresponding images were stored in a structured manner. The corresponding skin manager was configured to search for those images in the storage structure (e.g., in specific storage locations). In step 365, the skin manager searches the predefined structure using the search string. For example, skinmanager1 corresponding to back button 145 will go to the following file location to begin its search:

C:/com/windriver/skins/icestorm/gui_101/

As described previously, skinmanager1 has the following exemplary properties. The directory is C:/, the base package is com/windriver/skins, and the skin pack is icestorm/gui 101. Therefore, skinmanager1 goes to the above directory to search for the images for back button 145. In a first exemplary embodiment, the skin manager uses the skin name (e.g., backbutton) to find the images for the skinnable component and returns all the images for the skinnable button in step 370. For example, when searching for the images for back button 145 using the search string “backbutton”, skinmanager1 may find the following directory:

C:/com/windriver/skins/icestorm/gui_101/backbutton/

Skinmanager1 would then return all the images in this directory (e.g., normal.gif, pressed.gif, highlighted.gif, disabled.gif) in step 370. The skinnable component (e.g., back button 145) may then use these images to render itself on GUI 101 under the appropriate activity in step 375. In this exemplary embodiment, the state information remains with the skinnable component.

In a second exemplary embodiment, the search string may contain both the skin name and the particular state for which the skinnable component will be displayed. For example, the search string may be “backbutton/normal”. In this exemplary embodiment, skinmanager1 may find the same directory as described above using the “backbutton” portion of the search string, but may also continue within the directory to find the particular image associated with the state information in the search string, e.g.:

C:/com/windriver/skins/icestorm/gui_101/backbutton/normal.gif

Thus, in this example, skinmanager1 in step 370 would only return the single image corresponding to the state information in the search string.

In an alternative exemplary embodiment, the skin manager may implement a multi-tiered strategy to search and load the skin image from the search string. This embodiment may be used, for example, in a Java® application. For example, the skin manager may first search for the skin image on the file system if a file directory is specified in the configuration of the skin manager. If no directory is set or the image file is not found on the file system, the skin manager may then search the classpath. As is well known, a classpath lists the directories, .jar files (Java Archive file format), or .zip files that contain the compiled Java classes. Since these classes may be anywhere on the system or network, a developer may specify where the classes that need to be used are located. The contents of a classpath may vary depending on the system that is being run and how the directories are organized. Referring to process 350 of FIG. 7, in step 365, the skin manager will first search the file system and then search the class path if the image is not found in the file system. If the image is found in the file system in step 365, the skin manager will return the images from the file system in step 370. If the search in the file system in step 365 fails, the skin manager will search the class path and return the image(s) from the classpath in step 370.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A software package, comprising:
a graphical component including a plurality of images, each image corresponding to a state of the graphical component, wherein the graphical component is identified by a name; and
a skin manager configured to search for the graphical component in a predetermined location using the name and retrieve the graphical component.

2. The software package according to claim 1, wherein the skin manager retrieves each of the plurality of images.

3. The software package according to claim 1, wherein the skin manager searches the predetermined location using the name and state information and retrieves only the image corresponding to the state information.

4. The software package according to claim 1, wherein the graphical component is displayed as part of a graphical user interface for an application program.

5. The software package according to claim 1, wherein the predetermined location is a class path.

6. The software package according to claim 1, wherein the graphical component is stored in the predetermined location based on a set of predefined rules.

7. The software package according to claim 6, wherein the predefined rules include storing the graphical component in the same predetermined location as other graphical components displayed in one of an application program and a graphical user interface.

8. The software package according to claim 1, wherein the graphical component is configured using a graphical user interface.

9. The software package according to claim 1, wherein the states of the graphical component include one of a normal state, highlighted state, pressed state and disabled state.

10. A method, comprising the steps of:
identifying a graphical component by a name;
storing the graphical component in a predetermined location;
searching the predetermined location, using the name, for the graphical component; and
retrieving the graphical component.

11. The method of claim 10, further comprising the step of:
displaying the graphical component as part of a graphical user interface.

12. The method of claim 10, wherein the graphical component includes a plurality of images, each image corresponding to a state of the graphical component.

13. The method of claim 12, further comprising the steps of:
searching the predetermined location, using state information, for an image corresponding to the state information, wherein the state information corresponds to one of a first action taken by a user and a second action taken by an application program.

14. The method of claim 10, wherein the graphical component is a button.

15. The method of claim 10, wherein the skin name is a character string.

16. A method, comprising the steps of:
creating a skin including a plurality of images, each image corresponding to a state of the skin;
storing the skin in a predetermined location; and
linking a skin manager to the skin, wherein the skin manager includes methods to search the predetermined location.

17. The method according to claim 16, further comprising the step:
of creating the skin manager.

18. The method according to claim 17, wherein the skin manager is created via information entered on a graphical user interface.

19. The method according to claim 16, further comprising the step of:
creating a skin pack by storing other skins in the predetermined location.

20. The method according to claim 16, further comprising the steps of:
invoking the skin manager to search for the skin in the predetermined location; and
loading the skin into an application program for display.

21. A system, comprising,
a skin creation module, including a skin user interface, configured to create a skin including a plurality of images;
a skin manager creation module, including a skin manager user interface, configured to create a skin manager including methods to search a predetermined location; and
a skin development module configured to associate the skin manager with the skin.

22. The system according to claim 21, wherein each of the plurality of images correspond to a state of the skin.

23. The system according to claim 21, wherein the skin user interface is a graphical user interface.

24. The system according to claim 21, wherein the skin manager user interface is a graphical user interface.

25. The system according to claim 21, wherein the skin creation module stores the skin in the predetermined location.

26. The system according to claim 21, wherein the skin creation module stores the skin and other skins in the predetermined location to create a skin pack.
